(19) United States
(12) Patent Application Publication
(10) Pub. No.: US 2015/0192745 A1
(43) Pub. Date: Jul. 9, 2015

(54) OPTICAL FIBER CONNECTER AND OPTICAL COMMUNICATION MODULE

(71) Applicant: Hitachi Metals, Ltd., Tokyo (JP)

(72) Inventors: Kinya YAMAZAKI, Hitachi (JP); Masataka SATO, Hitachi (JP); Akira OGURA, Hitachi (JP); Shinji KOMATSUZAKI, Mito (JP)

(21) Appl. No.: 14/553,168

(22) Filed: Nov. 25, 2014

(30) Foreign Application Priority Data
Jan. 6, 2014 (JP) 2014-000303

(51) Int. Cl. G02B 6/38

(52) U.S. Cl. CPC G02B 6/3881

(57) ABSTRACT

An optical fiber connecter includes a first holding member including a positioning groove to position the optical fiber in a direction orthogonal to a longitudinal direction of the optical fiber, a second holding member including an accommodating groove including a substantially flat bottom surface and accommodating the optical fiber movably in the direction orthogonal to the longitudinal direction, the second holding member being configured such that the optical fiber is pressed against the positioning groove of the first holding member thereby, and a fixing member to fix the optical fiber to the accommodating groove of the second holding member at a position being away in a drawing direction of the optical fiber from an end of the positioning groove in the drawing direction.

The present application is based on Japanese patent application No. 2014-000303 filed on Jan. 6, 2014, the entire contents of which are incorporated herein by reference.

### BACKGROUND OF THE INVENTION

1. Field of the Invention

This invention relates to an optical fiber connecter and an optical communication module using the optical fiber connecter.

2. Description of the Related Art

Conventionally, in order to regularly arrange and connect distal ends of a plurality of optical fibers, an optical fiber connecter configured to use a substrate in which V-grooves configured to arrange optical fibers by one fiber per one groove are formed in parallel to each other and at an equal pitch is proposed (for example, JP-2003-337259 A1).

The optical fiber connecter includes a lower substrate (holding member) configured such that a plurality of V-grooves are formed therein in parallel to each other and at an equal pitch and an opposite substrate (holding member) configured such that a plurality of curved surface-grooves are formed therein in parallel to each other and at an equal pitch, and the optical fiber connecter is assembled in such a manner that a plurality of the optical fiber are respectively arranged in the V-grooves of the lower substrate by using a guide member, in the above-mentioned state an adhesive agent is coated in order to fix the optical fiber and the V-groove, the opposite substrate is pressed to the upper part of the V-groove so as to be fixed by using a jig, and the adhesive agent is exposed so as to be cured. The optical fiber is fixed between the lower substrate and the opposite substrate by the adhesive agent.

### SUMMARY OF THE INVENTION

In the conventional optical fiber connecter, a jig is needed upon the assembly so as to position the center of the groove of the curved surface of the opposite substrate to the center of the V-groove of the lower substrate with high accuracy. In addition, after the assembly, the optical fiber is fixed to the lower substrate and the opposite substrate by an adhesive agent and therefore it is difficult to separate the lower substrate and the opposite substrate from each other.

It is an object of the invention to provide an optical fiber connecter that upon the assembly eliminates the need for the high-accuracy positioning between a pair of holding members to hold the optical fiber, and after the assemble allows easy separation of the pair of the holding members from each other, as well as an optical communication module using the optical fiber connector.

(1) According to one embodiment of the invention, an optical fiber connecter comprises:

a first holding member comprising a positioning groove to position the optical fiber in a direction orthogonal to a longitudinal direction of the optical fiber;

a second holding member comprising an accommodating groove comprising a substantially flat bottom surface and accommodating the optical fiber movably in the direction orthogonal to the longitudinal direction, the second holding member being configured such that the optical fiber is pressed against the positioning groove of the first holding member thereby; and

a fixing member to fix the optical fiber to the accommodating groove of the second holding member at a position being away in a drawing direction of the optical fiber from an end of the positioning groove in the drawing direction.

In the above embodiment (1) of the invention, the following modifications and changes can be made.

(i) The fixing member comprises an adhesive agent to bond the optical fiber to the accommodating groove of the second holding member, and wherein the adhesive agent is disposed so as not to bond the optical fiber to a region of the accommodating groove opposite to the first holding member.

(ii) The optical fiber connecter further comprises a pressing member configured to resiliently press the second holding member against the first holding member, wherein the pressing member comprises an engaging part to engage with the first holding member at an end part thereof

(iii) The first holding member further comprises a surface on which an end surface of the optical fiber positioned by the positioning groove abuts.

(iv) The second holding member is configured so as to release a bent portion near the end surface of the optical fiber when the bent portion is caused.

(v) The first holding member is configured such that a plurality of the positioning grooves are formed therein, the positioning grooves being configured to position a plurality of the optical fibers arranged in parallel, in a parallel direction by one fiber per one groove, and wherein the second holding member is configured such that a plurality of the accommodating grooves are formed therein, the accommodating grooves being configured to accommodate a plurality of the optical fibers movably in the parallel direction by one fiber per one groove.

(2) According to another embodiment of the invention, an optical communication module comprises:

a first holding member comprising a first surface, a second surface opposite the first surface, a positioning groove to position the optical fiber in a direction orthogonal to a longitudinal direction of the optical fiber, and an optical path conversion surface to convert an optical path of the optical fiber, positioning groove and the optical path conversion surface being formed on the first surface;

a second holding member comprising an accommodating groove comprising a substantially flat bottom surface and accommodating the optical fiber movably in the direction orthogonal to the longitudinal direction, the second holding member being configured such that the optical fiber is pressed against the positioning groove of the first holding member thereby;

a fixing member to fix the optical fiber to the accommodating groove of the second holding member at a position being away in a drawing direction of the optical fiber from an end of the positioning groove in the drawing direction;

an optical element to be mounted on the second surface of the first holding member and to be optically coupled with the optical fiber via the optical path conversion surface; and

a semiconductor circuit element to be mounted on the second surface of the first holding member.

In the above embodiment (2) of the invention, the following modifications and changes can be made.

(vi) The first holding member further comprises an optical groove with the optical path conversion surface formed therein, and wherein the second holding member is configured so as to cover the optical groove.

### ADVANTAGEOUS EFFECTS OF THE INVENTION

According to one embodiment of the invention, an optical fiber connector can be provided that upon the assembly eliminates the need for the high-accuracy positioning between a pair of holding members to hold the optical fiber, and after the assemble allows easy separation of the pair of the holding members from each other, as well as an optical communication module using the optical fiber connector.

### BRIEF DESCRIPTION OF THE DRAWINGS

The preferred embodiments according to the invention will be explained below referring to the drawings, wherein:

FIG. 1 is a plan view schematically showing a configuration example of an optical communication module to which an optical fiber connecter according to a first embodiment of the invention is applied;

FIG. 2 is a cross-sectional view taken along the line A-A in FIG. 1;

FIG. 3 is a cross-sectional view taken along the line B-B in FIG. 1;

FIG. 4 is a cross-sectional view taken along the line C-C in FIG. 1;

FIG. 5 is an exploded perspective view schematically showing an optical fiber connecter and the peripheral part thereof;

FIG. 6 is a bottom view of the holding substrate viewed from the lower surface side;

FIG. 7 is an explanatory view showing a meaning of an adhesion region;

FIG. 8 is a cross-sectional view corresponding to FIG. 2, in case of a second embodiment of the invention;

FIG. 9A is a cross-sectional view corresponding to FIG. 2, in case of a third embodiment of the invention;

FIG. 9B is an enlarged cross-sectional view schematically showing the proximity of the end surface of the optical fiber;

FIG. 10 is an exploded perspective view schematically showing an optical fiber connecter according to a fourth embodiment of the invention and the peripheral part thereof, and

FIG. 11 is a cross-sectional view corresponding to FIG. 2, in case of a fourth embodiment of the invention.

### DETAILED DESCRIPTION OF THE PREFERRED EMBODIMENTS

Hereinafter, the preferred embodiments according to the invention will be explained referring to the drawings. Further, in each drawing, with regard to the components having the substantially same function, the same reference signs will be used, and an overlapping explanation will be omitted.

### First Embodiment

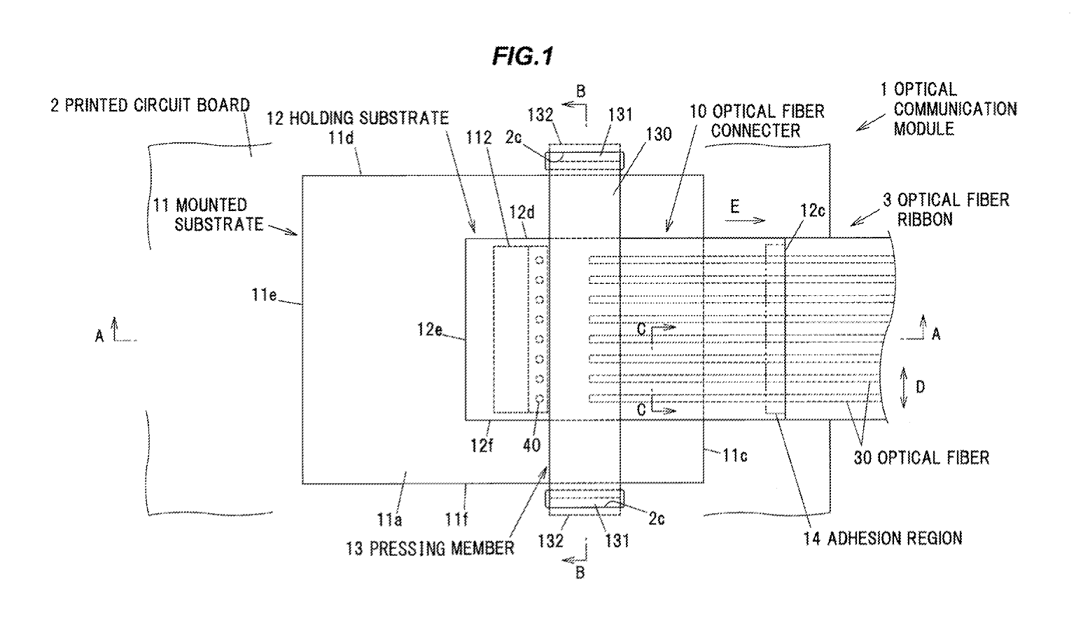

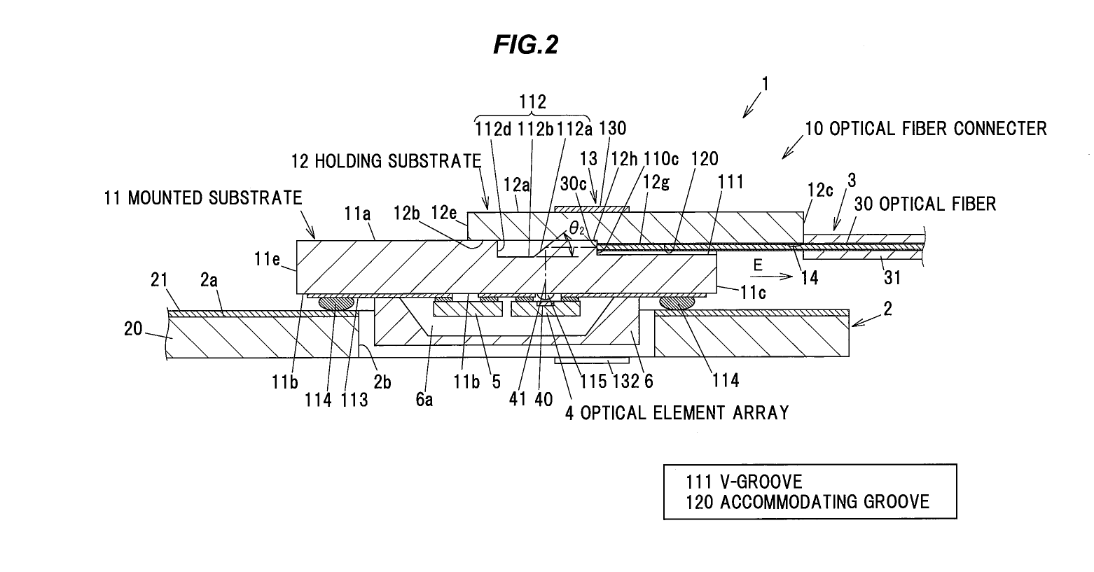

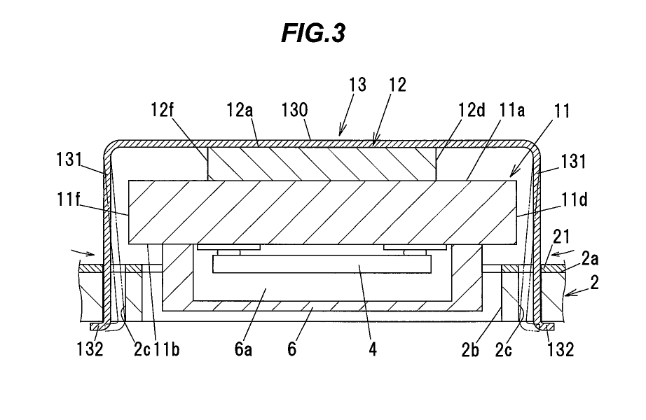

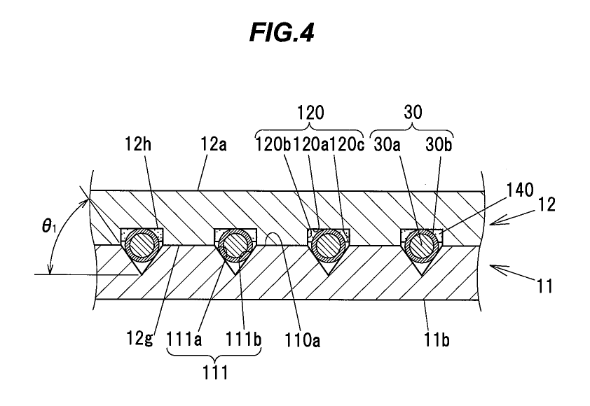

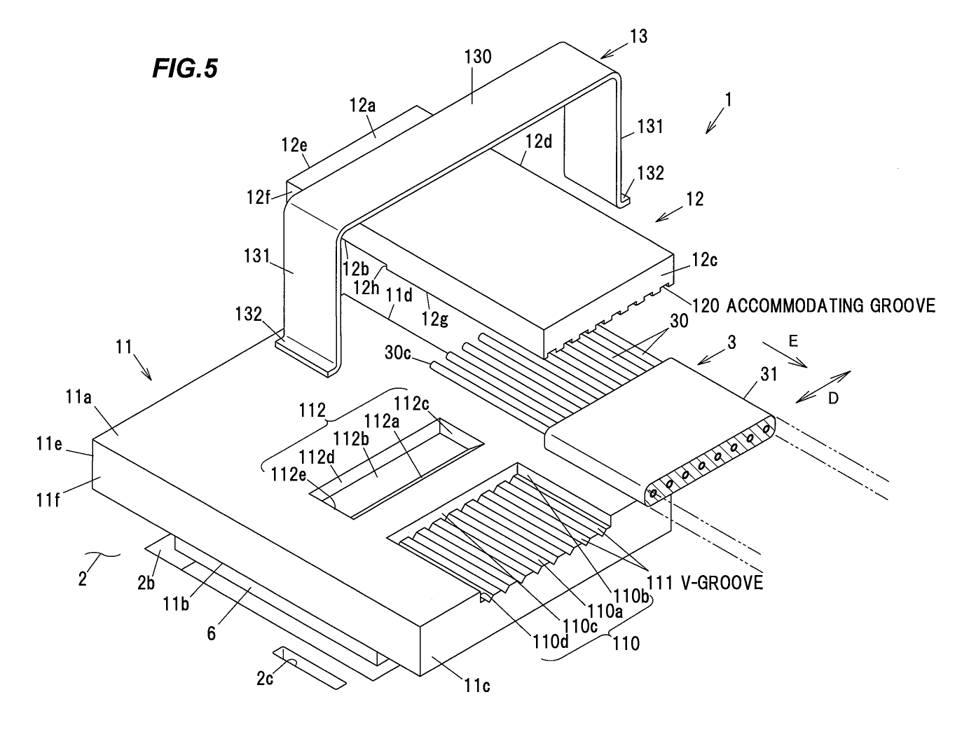

FIG. 1 is a plan view schematically showing a configuration example of an optical communication module to which the optical fiber connecter according to the first embodiment of the invention is applied, FIG. 2 is a cross-sectional view taken along the line A-A in FIG. 1, FIG. 3 is a cross-sectional view taken along the line B-B in FIG. 1, and FIG. 4 is a cross-sectional view taken along the line C-C in FIG. 1. FIG. 5 is an exploded perspective view schematically showing the optical fiber connecter and the peripheral part thereof. FIG. 1 to FIG. 5 show only one optical communication module, but does not show the other optical communication module.

This optical communication module 1 includes a printed circuit board 2; an optical fiber connecter 10 configured to have a mounted substrate 11 configured to position a position of a plurality (8 cores in the embodiment) of optical fibers 30 exposed from an optical fiber ribbon 3, in a direction orthogonal to the longitudinal direction (a parallel direction) D, a holding substrate 12 configured to hold a plurality of the optical fibers 30 exposed from the optical fiber ribbon 3, and a pressing member 13 configured to resiliently press the holding member 12 against the mounted substrate 11, an optical element array 4 and a semiconductor circuit element 5 configured to be mounted on a rear surface 11b of the mounted substrate 11; and a cover 6 configured to air-tightly seal the optical element array 4 and the semiconductor circuit element 5. Here, the mounted substrate 11 is one example of the first holding member, and the holding substrate 12 is one example of the second holding member. In addition, the optical element array 4, the semiconductor circuit element 5, the cover 6 and the mounted substrate 11 constitute an optical module.

(Printed Circuit Board)

The printed circuit board 2 includes a substrate 20 comprised of a glass epoxy resin or the like having an insulating property, and on the upper surface 2a of the substrate 20, a wiring pattern 21 configured to be connected to the optical element array 4 and the semiconductor circuit element 5 is formed. In addition, an opening 2b in which the cover is arranged and a pair of engaging holes 2c in which the pressing member 13 is locked are formed in a part of the printed circuit board 2 located under the mounted substrate 11. In addition, in order to carry out an optical communication between the other optical communication module by using the optical fiber ribbon 3 as a transmission medium, electronic components (not shown) such as a CPU (Central Processing Unit), an memory element are mounted in the printed circuit board 2.

(Optical Fiber Ribbon)

The optical fiber ribbon 3 includes a plurality of the optical fiber 30 configured to be arranged in parallel, and a covering member 31 configured to collectively cover the optical fiber 30 in such a manner that the both end parts of thereof are exposed. The optical fiber 30 is configured to include a core 30a and a clad 30b formed around the core 30a. As the optical fiber 30, for example, a multi-mode optical fiber or a single-mode optical fiber of which clad 30b has a diameter of 125 μm is used. Further, the optical fiber 30 can be also configured such that a covering layer is formed around the clad 30b. In this case, the optical fiber 30 exposed from the covering member 31 can remain having the covering layer. By this, the clad 30b can be protected.

The optical element array 4 is a light emitting array or a light receiving array configured to have a plurality of optical elements in an array-like shape configured to transmit or receive an optical signal. An example of the former includes a semiconductor laser such as a VCSEL (Vertical Cavity Surface Emitting Laser), and a light emitting element such as a LED (Light Emitting Diode). In addition, an example of the latter includes a light receiving element such as a photo diode. The optical element array 4 is a surface-type optical element array configured such that a light is emitted or made incident from a light receiving and emitting part 40 formed in an opposite surface to the mounted surface. In case of using a light emitting element as the optical element array 4 shown in the above-mentioned drawings, as the optical element array of the other optical communication module configured to carry out an optical communication by the optical fiber ribbon 3, a light receiving element array is used. Further, the optical element array 4 can be configured such that, of a plurality of optical elements, the light emitting element is used as a part of the optical elements and the light receiving element is used as residual optical elements. By this, a bidirectional optical communication can be carried out. The light receiving and emitting part 40 of the optical element array 4 of the embodiment is arranged in the parallel direction D, for example, at a pitch of 250 μm.

The semiconductor circuit element 5 is a driver IC configured to driver an light emitting element, if the optical element array 4 is a light emitting element array, and is a preamplifier configured to amplify an output signal of a light receiving element, if the optical element array 4 is a light receiving element array.

The cover 6 has a space part 6a configured to accommodate the optical element array 4 and the semiconductor circuit element 5, and is comprised of, for example, silicon. The cover 6 is joined to the rear surface 11b of the mounted substrate 11 by, for example, a normal temperature junction method. The normal temperature junction method is a method that the surfaces to be joined are cleaned by a sputter etching of, for example, plasma, ion beam so as to be joined at a normal temperature.

(Mounted Substrate)

The mounted substrate 11 has almost a rectangular parallelepiped shape comprised of a front surface 11a as the first surface, the rear surface 11b as the second surface and side surfaces 11c to 11f. As the material of the mounted substrate 11, a material such as silicon, quarts glass, transparent to a light that the optical element array 4 emits or receives can be used. It is preferable that the material of the mounted substrate 11 is a single-crystal silicon in terms of being able to fabricate the V-groove 111 and the reflection surface 112a that have high accuracy. In addition, the mounted substrate 11 is configured such that the step part 110 comprised of the bottom surface 110a, and the side surface 110b to 110d is formed in one end part in the longitudinal direction, and in the bottom surface 110a of the step part 110, a plurality of the V-grooves 111 configured to position the positions of a plurality of the optical fibers 30 in the parallel direction D are formed. In addition, the mounted substrate 11 is configured such that the reflection groove 112 having the reflection surface 112a configured to convert the optical path 41 of the optical element array 4 by 90 degrees is formed between the step part 110 and the side surface 11e. The reflection groove 112 is comprised of the above-mentioned reflection surface 112a, the bottom surface 112b, and the side surfaces 112c to 112e. The V-groove 111 is formed in a predetermined length from one side surface 11c to the other side surface 11e along the longitudinal direction of the optical fiber 30. The V-groove 111 is one example of the positioning groove, and is comprised of a pair of inner surfaces 111a, 111b having a predetermined opening angle. The reflection surface 112a is one example of the optical path conversion surface configured to convert the optical path 41 between the optical fiber 30 and the optical element array 4. Further, metal plating can be applied to the reflection surface 112a.

The wiring pattern 113 configured to connect the optical element array 4 and the semiconductor circuit element 5, and the wiring pattern 21 of the printed circuit board 2 is formed in the rear surface 11b of the mounted substrate 11, and the wiring pattern 113 of the mounted substrate 11 and the wiring pattern 21 of the printed circuit board 2 are connected by the solder ball 114. In addition, in the rear surface 11b of the mounted substrate 11, the condensing lens 115 is formed in a position facing the light receiving and emitting part 40 of the optical element array 4.

(V-groove and Reflection Groove)

The V-groove 111 and the reflection groove 112 can be formed by MEMS (Micro Electro Mechanical System) technique such as dry etching, wet etching. For example, the front surface 11a of the mounted substrate 11 of a single crystal silicon is configured to be a predetermined crystal surface and the V-groove 111 and the reflection groove 112 are fabricated by an anisotropic wet etching, thereby a predetermined crystal surface appears in the inner surfaces 111a, 111b of the V-groove 111 and the reflection surface 112a so that the angle and the etching depth of the inner surfaces 111a, 111b of the V-groove 111 and the reflection surface 112a can be almost homogenized over the whole of the mounted substrate 11. For example, in case that the front surface 11a of the mounted substrate 11 is configured to be a (100) crystal surface, the inner surfaces 111a, 111b of the V-groove 111 become a (111) crystal surface of which inclination angle θ₁ (shown in FIG. 4) is 54.7 degrees and the reflection surface 112a become a (110) crystal surface of which inclination angle θ₂ (shown in FIG. 2) is 45 degrees.

(Holding Substrate)

The holding substrate 12 has almost a rectangular parallelepiped shape comprised of the upper surface 12a, the lower surface 12b, the side surfaces 12c to 12f and the convex part 12g configured to project downward from the lower surface 12b and be fitted to the step part 110 of the mounted substrate 11. In addition, the holding substrate 12 is configured such that a plurality of the accommodating grooves 120 configured to accommodate a plurality of the optical fibers 30 movably in the parallel direction D by one fiber per one groove are formed in the convex part 12g. The accommodating groove 120 is formed from one side surface 12c to the other side surface 12e along the longitudinal direction of the optical fiber 30 so as to be longer than the V-groove 111. The accommodating groove 120 is comprised of the bottom surface 120a of almost a flat surface, and a pair of side surfaces 120b, 120c formed in both sides of the bottom surface 120a. The holding substrate 12 has a size that covers the whole of the reflection groove 112 of the mounted substrate 11. As the material of the holding substrate 12, for example, a resin, quarts glass, silicon, a metal or the like can be used. The accommodating groove 120 has a width of, for example, 1.4 d (175) to 1.6 d (200 μm), if the diameter (d) of the optical fiber 30 is 125 μm. The bottom surface 120a of the accommodating groove 120 can be a curved surface swollen to the upper surface 12a side, if the optical fiber 30 is movable in the parallel direction D thereof. In addition, the bottom surface 120a can be configured such that the corner parts between the side surfaces 120b, 120c is comprised of a curved surface or an inclined surface, and the plat portion except for the corner parts is not less than 70% of a whole.

The width in the parallel direction D of the convex part 12g of the holding substrate 12 is formed in a size slightly smaller than the width in the parallel direction D of the step part 110 of the mounted substrate 11. By this, the center of the accommodating groove 120 in the width direction can be easily matched to the center of the V-groove 111 in the width direction only by fitting the convex part 12g to the step part 110.

In addition, the holding substrate 12 is configured to bond the optical fiber 30 by the adhesive agent 140 to the position of a plurality of the accommodating grooves 120 that the V-grooves 111 of the mounted substrate 11 do not face, namely the adhesion region 14 separated from the end part of the V-groove 111 in the drawing direction E of the optical fiber 30 by a predetermined distance (for example, 2 to 3 mm) in the drawing direction E. Here, the adhesive agent 140 is one example of the fixing member. Further, the optical fiber 30 can be pressed against the bottom surface 120a of the accommodating groove 120 so as to be fixed by a fixing member such as a plate-like member, together with the adhesive agent 140 or instead of the adhesive agent 140.

(Pressing Member)

The pressing member 13 is comprised of a metal plate having a spring property, and includes a flat-shaped pressing part 130, a pair of leg parts 131 configured to be bent almost at a right angle in the direction from the pressing part 130 to the printed circuit board 2, and the locking part 132 configured such that the tips of the pair of leg parts 131 are bent almost at a right angle outward so as to be locked with the engaging holes 2c of the printed circuit board 2. The pressing member 13 can be removed from the printed circuit board 2 by the pair of leg parts 131 being bent inward so as to release the locking part 132 from the engaging holes 2c. Further, the pressing member 13 can be also configured such that a pair of the locking parts 132 is formed in a shape bent inward so that the locking parts 132 are locked with the engaging holes 2c. In addition, in case that the width of the printed circuit board 2 is relatively small, the pair of the locking parts 132 bent inward can be also locked with the end parts in the width direction of the printed circuit board 2 without forming the engaging holes 2c in the printed circuit board 2. In this case, the pair of leg parts 131 is bent outward so as to mount the pressing member 13 in the end parts in the width direction of the printed circuit board 2.

(Assembling Method of Optical Communication Module 1)

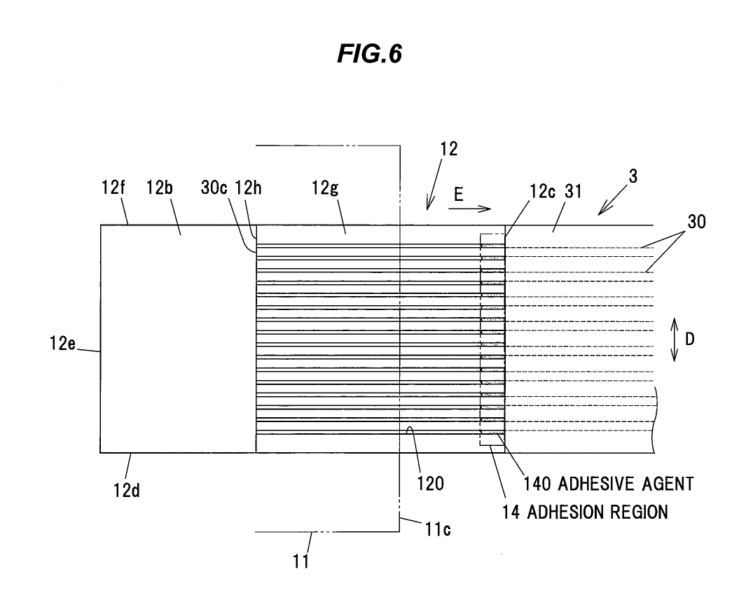

Next, one example of an assembling method of the optical communication module 1 according to the embodiment will be explained referring to FIG. 6. FIG. 6 is a bottom view of the holding substrate 12 viewed from the lower surface 12b side.

First, as shown in FIG. 6, each optical fiber 30 exposed from the optical fiber ribbon 3 is respectively arranged at almost the center of each accommodating groove 120 of the holding substrate 12. At this time, the end surface 30c of the optical fiber 30 is matched with the end surface 12h of the convex part 12g. Next, the accommodating groove 120 in the adhesion region 14 is coated with the adhesive agent 140. As the adhesive agent 140, for example, an ultraviolet curing resin is used. The adhesive agent 140 is irradiated with ultraviolet light so as to be cured, so that the optical fiber 30 is bonded to the accommodating groove 120. Further, the adhesive agent 140 is not limited to the ultraviolet curing resin. In addition, if the positions of the end surface 30c of each optical fiber 30 are aligned, the end surface 30c of the optical fiber 30 can be projected from the end surface 12h of the convex part 12g.

Then, the optical element array 4 and the semiconductor circuit element 5 are mounted in the rear surface 11b of the mounted substrate 11. The optical element array 4 and the semiconductor circuit element 5 are covered by the cover 6.

Then, the convex part 12g of the holding substrate 12 is fitted to the step part 110 of the mounted substrate 11, and the optical fiber 30 is pressed against the V-groove 111 of the mounted substrate 11 by the holding substrate 12. At this time, the end surface 12h of convex part 12g of the holding substrate 12 is brought into contact with the side surface 110c of the mounted substrate 11. Thereby, the end surface 30c of the optical fiber 30 is brought into contact with the side surface 110c of the mounted substrate 11. Further, if optical loss is within an allowable range, a certain gap can occur between the end surface 30c and the side surface 110c.

Then, the mounted substrate 11 configured such that the optical element array 4 and the semiconductor circuit element 5 covered by the cover 6 are mounted therein is mounted in the printed circuit board 2. Namely, the wiring pattern 113 of the mounted substrate 11 is connected to the wiring pattern 21 of the printed circuit board 2 by the solder ball 114.

Then, the holding substrate 12 is pressed against the mounted substrate 11 by the pressing member 13. Namely, in a state that a pair of the leg parts 131 of the pressing member 13 are bent inward, the locking parts 132 located at the tip are inserted into the engaging holes 2c of the printed circuit board 2, and the pair of the leg parts 131 are released. The pair of the leg parts 131 are moved outward so as to be returned and the locking parts 132 are locked with the engaging holes 2c, so as to have a state that the pressing member 13 presses the holding substrate 12 against the holding substrate 12. In this way, the optical communication module 1 is assembled.

(Modified Examples of Assembling Method)

Further, an adhesion step of the optical fiber 30 to the holding substrate 12 can be carried out as follows. Namely, each optical fiber 30 not bonded is respectively arranged in each V-groove 111 of the mounted substrate 11. At this time, the end surface 30c of the optical fiber 30 is brought into contact with the side surface 110c of the step part 110 of the mounted substrate 11.

Then, the convex part 12g of the holding substrate 12 is fitted to the step part 110 of the mounted substrate 11, and the optical fiber 30 is pressed against the V-groove 111 of the mounted substrate 11 by the holding substrate 12. At this time, the end surface 12h of convex part 12g of the holding substrate 12 is brought into contact with the side surface 110c of the mounted substrate 11. In the above-mentioned state, as shown in FIG. 6, the accommodating groove 120 in the adhesion region 14 is coated with the adhesive agent 140 and the adhesive agent 140 is cured, so that the optical fiber 30 is bonded to the accommodating groove 120.

(Operation of Optical Communication Module 1)

Then, an operation example of the optical communication module 1 will be explained, in case that the optical element array 4 shown in FIG. 1 is a light emitting element array and the semiconductor circuit element 5 shown in FIG. 1 is a driver IC. When a control signal is transmitted to the driver IC from a CPU (not shown) mounted on the printed circuit board 2, the driver IC transmits a drive signal to the light emitting element array based on the control signal transmitted. Each light receiving and emitting part 40 of the light emitting element array emits an optical signal toward the mounted substrate 11, the optical signal having a frequency band of, for example, 1 μm, according to the drive signal transmitted from the driver IC. The optical signal is condensed at the condensing lens 115, and then is reflected by the reflection surface 112a of the mounted substrate 11 and propagates through the mounted substrate 11, so as to be made incident into the core 30a of the optical fiber 30. The optical signal made incident into the core 30a propagates through the core 30a so as to be emitted from the other end part of the optical fiber 30.

The optical signal transmitted via the optical fiber 30 is reflected by the reflection surface of the mounted substrate of the other optical communication module, and then the optical signal is made incident into a light receiving element array. The light receiving element array converts the optical signal received to an electrical signal according to the intensity so as to output it to a preamplifier IC. Then the preamplifier IC amplifies the electrical signal output from the light receiving element array so as to output it to a CPU (not shown) mounted on the printed circuit board.

(Advantageous Effect of First Embodiment)

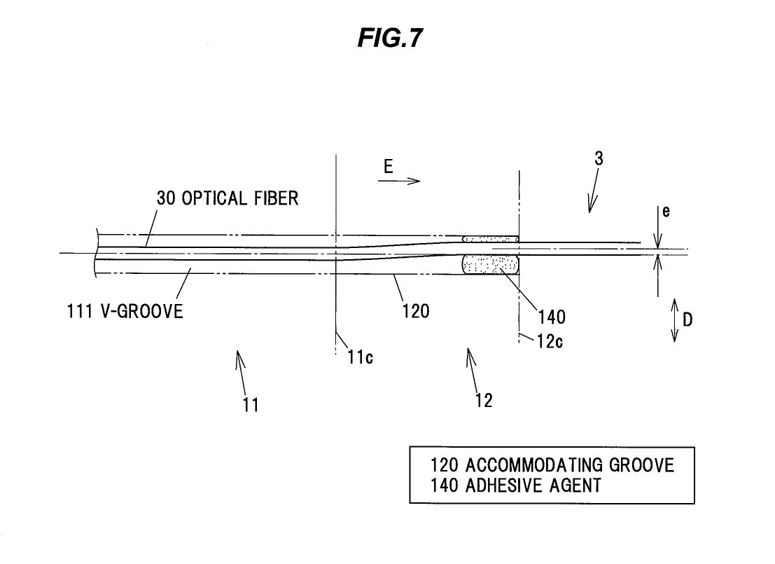

Next, the advantageous effect of the above-mentioned first embodiment will be explained referring to FIG. 7.

(1) The optical fiber 30 is bonded to the holding substrate 12, but is not bonded to the mounted substrate 11, thus the mounted substrate 11 and the holding substrate 12 to which the optical fiber 30 is bonded can be easily separated from each other, if the pressing member 13 is removed from the printed circuit board 2 after assembly. Consequently, the inspection and replacement of components such as the optical element array 4, the semiconductor circuit element 5 mounted in the mounted substrate 11 can be easily carried out.

(2) FIG. 7 is an explanatory view showing a meaning of the adhesion region 14. FIG. 7 shows a state that the optical fiber 30 is displaced in the parallel direction D by a displacement amount (e) from the center of the V-groove 111, namely the center of the accommodating groove 120 so as to be bonded to the accommodating groove 120 by the adhesive agent 140. According to the embodiment, the accommodating groove 120 accommodates the optical fiber 30 movably in the parallel direction D, and the optical fiber 30 is bonded to the accommodating groove 120 by the adhesive agent 140 in a position (the adhesion region 14) separated from the end part of the V-groove 111. Thus, the bent portion of the optical fiber 30 is corrected until the optical fiber 30 reaches the V-groove 111 from the adhesion region 14 so that the optical fiber 30 can be matched with the center of the V-groove 111. Consequently, at the time of assembling, the optical fiber 30 can be positioned with high accuracy without carrying out a positioning with high accuracy between the mounted substrate 11 and the holding substrate 12.

(3) The reflection groove 112 having the reflection surface 112a is covered by the holding substrate 12, thus reduction of reflection efficiency due to adhesion of dust can be prevented.

### Second Embodiment

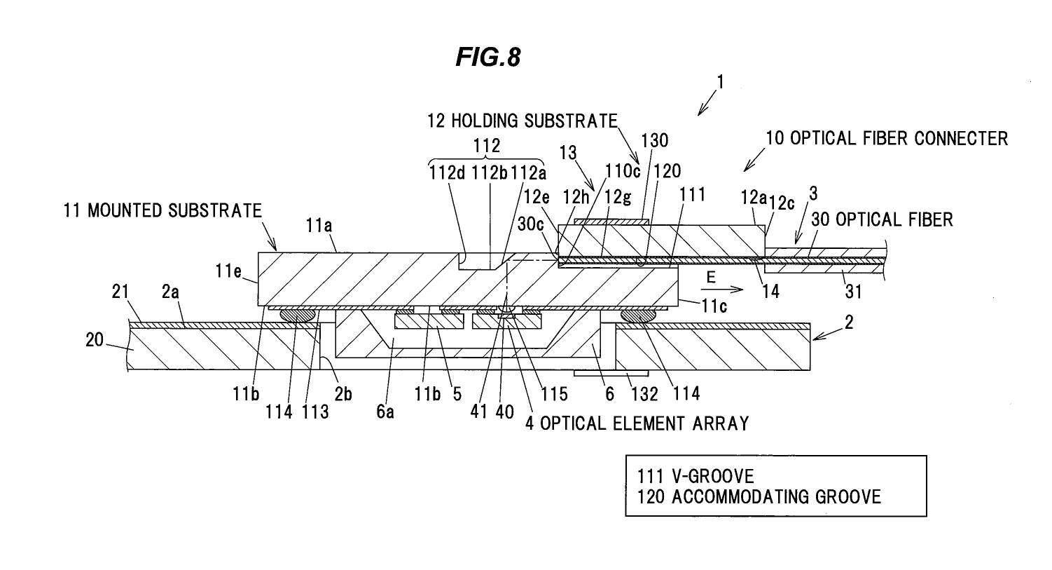

FIG. 8 is a cross-sectional view corresponding to FIG. 2, in case of the second embodiment of the invention. In the first embodiment, a configuration that the holding substrate 12 covers the reflection groove 112 of the mounted substrate 11 is adopted, but in the embodiment, a configuration that the holding substrate 12 is decreased in size and does not cover the reflection groove 112 is adopted, and except for the above, the embodiment is configured in the same way as the first embodiment.

The holding substrate 12 has a rectangular parallelepiped shape comprised of the upper surface 12a, the side surfaces 12c to 12f and the convex part (corresponding to the lower surface) 12g. A plurality of the accommodating grooves 120 are formed in the convex part 12g in the same way as the first embodiment.

According to the second embodiment, except for the effect that the holding substrate 12 covers the reflection groove 112, the same effect as that of the first embodiment is exerted, and simultaneously the holding substrate 12 can be reduced in size.

### Third Embodiment

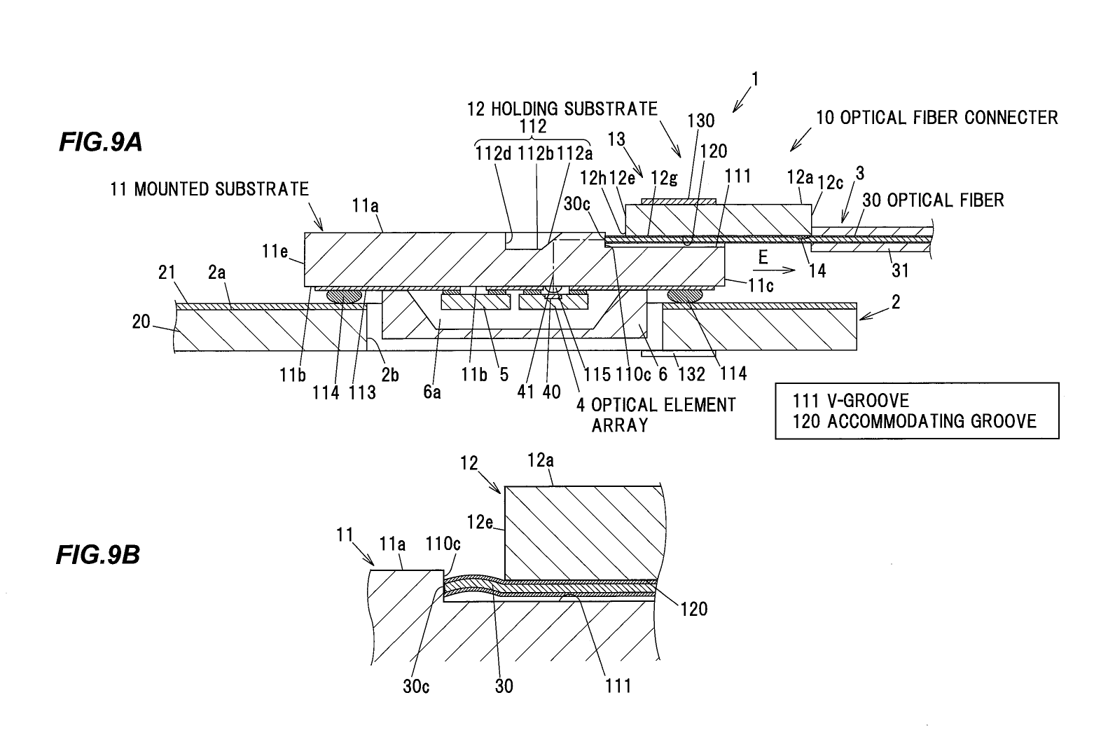

FIG. 9A is a cross-sectional view corresponding to FIG. 2, in case of the third embodiment of the invention, and FIG. 9B is an enlarged cross-sectional view schematically showing the proximity of the end surface 30c of the optical fiber 30. In the second embodiment, the side surface 12e of the holding substrate 12 is brought into contact with the side surface 110c of the mounted substrate 11, but in the third embodiment, the side surface 12e of the holding substrate 12 is separated from the side surface 110c of the mounted substrate 11, and except for the above, the embodiment is configured in the same way as the second embodiment.

The side surface 12e of the holding substrate 12 is separated from the side surface 110c of the mounted substrate 11, thereby, as shown in FIG. 9B, even if a bent portion occurs upward, when the end surface 30c of the optical fiber 30 is pressed against the side surface 110c of the mounted substrate 11, a space for releasing the bent portion can be secured.

According to the third embodiment, the same effect as the second embodiment is exerted, and simultaneously the end surface 30c of the optical fiber 30 can be easily pressed against the side surface 110c of the mounted substrate 11, and all the end surfaces 30c of the optical fibers 30 can be brought into contact with the side surface 110c of the mounted substrate 11. Further, the holding substrate 12 only has to have a shape configured such that even if a bent portion occurs in the proximity of the end surfaces 30c of the optical fibers 30, the bent portion can be released, and for example, the holding substrate 12 can be configured such that a concave part is formed in the proximity of the end surfaces 30c of the optical fibers 30.

### Fourth Embodiment

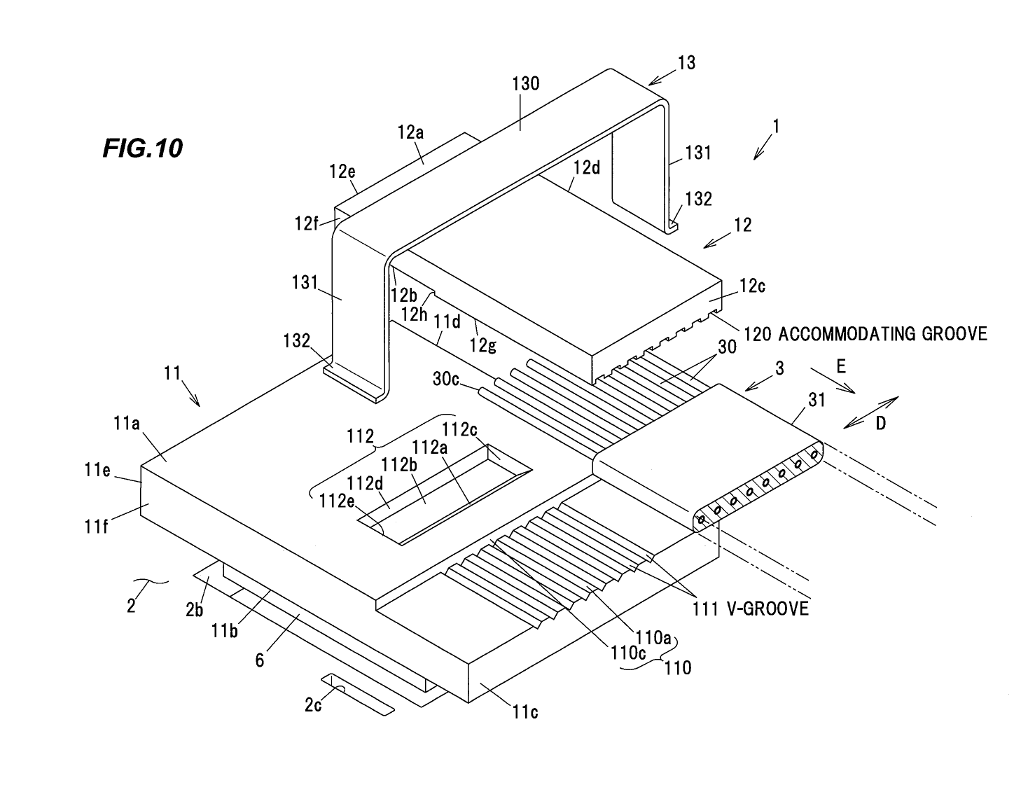

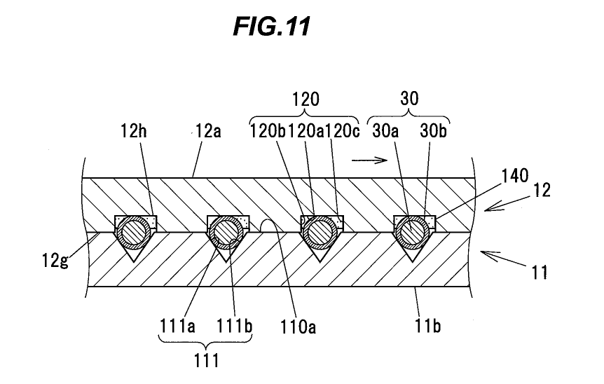

FIG. 10 is an exploded perspective view schematically showing the optical fiber connecter according to the fourth embodiment of the invention and the peripheral part thereof. FIG. 11 is a cross-sectional view corresponding to FIG. 2, in case of the fourth embodiment of the invention. In each of the above-mentioned embodiments, for the purpose of positioning, the convex part 12g of the holding substrate 12 is fitted to the step part 110 of the mounted substrate 11, but in the embodiment, the above-mentioned fitting structure is not included.

Namely, as shown in FIG. 10, in the embodiment, the mounted substrate 11 has almost a rectangular parallelepiped shape comprised of a front surface 11a, the rear surface 11b and the side surfaces 11c to 11f in the same manner as the first embodiment. In addition, the mounted substrate 11 is configured such that the step part 110 comprised of the bottom surface 110a and the side surface 110c (the side surfaces 110b, 110d shown in FIG. 5 are excepted) is formed in one end part in the longitudinal direction, and in the bottom surface 110a of the step part 110, a plurality of the V-grooves 111 configured to position the positions of a plurality of the optical fibers 30 in the parallel direction D are formed.

According to the embodiment, the accommodating groove 120 is configured to accommodate a plurality of the optical fibers 30 movably in the parallel direction D, thus, as shown in FIG. 11, even if the holding substrate 12 slightly deviates from the mounted substrate 11 in the parallel direction D, the optical fibers 30 can be held by the bottom surface 120a of the accommodating groove 120.

(Summary of the Embodiments)

Next, technical ideas grasped from the embodiments explained above will be described referring to the reference signs or the like in the embodiments. However, each of the reference signs or the like in the following description does not limit the constitutional elements in the scope of claims to the components or the like particularly shown in the embodiments.

[1] An optical fiber connecter, comprising a first holding member (11) comprising a positioning groove (111) to position the optical fiber (30) in a direction (D) orthogonal to the longitudinal direction of the optical fiber (30), a second holding member (12) comprising an accommodating groove (120) comprising a substantially flat bottom surface (120a) and accommodating the optical fiber (30) movably in the direction (D) orthogonal to the longitudinal direction, the second holding member (12) being configured such that the optical fiber (30) is pressed against the positioning groove (111) of the first holding member (11) thereby, and a fixing member (140) to fix the optical fiber (30) to the accommodating groove (120) of the second holding member (12), wherein the fixing member (140) is disposed at a position being away in a drawing direction (E) of the optical fiber (30) from an end part of the positioning groove (111) in the drawing direction (E).

[2] The optical fiber connecter according to [1], wherein the fixing member comprises an adhesive agent (140) to bond the optical fiber (30) to the accommodating groove (120) of the second holding member (12), and the adhesive agent (140) is disposed not to bond the optical fiber (30) to the positioning groove (111) of the first holding member (11).

[3] The optical fiber connecter according to [1] or [2], further comprising a pressing member (13) comprising an engaging part (132) to engage with the first holding member (11) at an end part thereof, and to resiliently press the second holding member (12) against the first holding member (11).

[4] The optical fiber connecter according to any one of [1] to [3], wherein the first holding member (11) further comprises a surface (110c) on which the end surface (30c) of the optical fiber (30) positioned by the positioning groove (111) abuts.

[5] The optical fiber connecter according to [4], wherein the second holding member (12) is configured so as to release a bent portion near the end surface (30c) of the optical fiber (30) when the bent portion is caused.

[6] The optical fiber connecter according to [1], wherein the first holding member (11) is configured such that a plurality of the positioning grooves are formed therein, the positioning grooves (111) being configured to position a plurality of the optical fibers (30) arranged in parallel, in a parallel direction (D) by one fiber per one groove, and wherein the second holding member (12) is configured such that a plurality of the accommodating grooves (120) are formed therein, the accommodating grooves (120) being configured to accommodate a plurality of the optical fibers (30) movably in the parallel direction (D) by one fiber per one groove.

[7] An optical communication module, comprising a first holding member (11) comprising a first surface (11a), a second surface (11b) opposite the first surface (11a), a positioning groove (111) to position a position of the optical fiber (30) in a direction orthogonal to the longitudinal direction of the optical fiber (30), and an optical path conversion surface (112a) to convert an optical path of the optical fiber (30), the positioning groove (111) and the optical path conversion surface (112a) being formed on the first surface (11a), a second holding member (12) comprising an accommodating groove (120) comprising a substantially flat bottom surface (120a) and accommodating the optical fiber (30) movably in the direction orthogonal to the longitudinal direction, and the second holding member (12) being configured such that the optical fiber (30) is pressed against the positioning groove (111) of the first holding member (11) thereby, a fixing member (140) to fix the optical fiber (30) to the accommodating groove (120) of the second holding member (12), an optical element (4) to be mounted on the second surface (11b) of the first holding member (11) and to be optically coupled with the optical fiber (30) via the optical path conversion surface (112a), and a semiconductor circuit element (5) to be mounted on the second surface (11b) of the first holding member (11), wherein the fixing member (140) is disposed at a position being away in a drawing direction (E) of the optical fiber (30) from an end part of the positioning groove (111) in the drawing direction (E).

[8] The optical communication module according to [7], wherein the first holding member (11) further comprises an optical groove (112) with the optical path conversion surface (112a) formed therein, and wherein the second holding member (12) is configured so as to cover the optical groove (112).

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

Particularly, the embodiments of the invention are not limited to each of the above-mentioned embodiments, various embodiments can be adopted. For example, in each of the above-mentioned embodiments, an adhesive agent is used as a means for fixing the optical fiber 30 to the holding substrate 12, but the optical fiber 30 can be fixed by pressing the optical fiber 30 against the bottom surface 120a of the accommodating groove 120 by using a band or the like.

In addition, in each of the above-mentioned embodiments, a plurality of the optical fiber 30 are used as a transmission medium, but the invention is not limited to this, and can be also applied to a case that one optical fiber 30 is used.

### INDUSTRIAL APPLICABILITY

The invention is preferably used for an optical communication module configured to carry out an optical communication in a server and a super computer, or between computers, and an optical fiber connecter used in the optical communication module.

What is claimed is:

1. An optical fiber connecter, comprising:
a first holding member comprising a positioning groove to position the optical fiber in a direction orthogonal to a longitudinal direction of the optical fiber;
a second holding member comprising an accommodating groove comprising a substantially flat bottom surface and accommodating the optical fiber movably in the direction orthogonal to the longitudinal direction, the second holding member being configured such that the optical fiber is pressed against the positioning groove of the first holding member thereby; and
a fixing member to fix the optical fiber to the accommodating groove of the second holding member at a position being away in a drawing direction of the optical fiber from an end of the positioning groove in the drawing direction.

2. The optical fiber connecter according to claim 1, wherein the fixing member comprises an adhesive agent to bond the optical fiber to the accommodating groove of the second holding member, and
wherein the adhesive agent is disposed so as not to bond the optical fiber to a region of the accommodating groove opposite to the first holding member.

3. The optical fiber connecter according to claim 1, further comprising a pressing member configured to resiliently press the second holding member against the first holding member,
wherein the pressing member comprises an engaging part to engage with the first holding member at an end part thereof.

4. The optical fiber connecter according to claim 1, wherein the first holding member further comprises a surface on which an end surface of the optical fiber positioned by the positioning groove abuts.

5. The optical fiber connecter according to claim 4, wherein the second holding member is configured so as to release a bent portion near the end surface of the optical fiber when the bent portion is caused.

6. The optical fiber connecter according to claim 1, wherein the first holding member is configured such that a plurality of the positioning grooves are formed therein, the positioning grooves being configured to position a plurality of the optical fibers arranged in parallel, in a parallel direction by one fiber per one groove, and
wherein the second holding member is configured such that a plurality of the accommodating grooves are formed therein, the accommodating grooves being configured to accommodate a plurality of the optical fibers movably in the parallel direction by one fiber per one groove.

7. An optical communication module, comprising:
a first holding member comprising a first surface, a second surface opposite the first surface, a positioning groove to position the optical fiber in a direction orthogonal to a longitudinal direction of the optical fiber, and an optical path conversion surface to convert an optical path of the optical fiber, positioning groove and the optical path conversion surface being formed on the first surface;
a second holding member comprising an accommodating groove comprising a substantially flat bottom surface and accommodating the optical fiber movably in the direction orthogonal to the longitudinal direction, the second holding member being configured such that the optical fiber is pressed against the positioning groove of the first holding member thereby;
a fixing member to fix the optical fiber to the accommodating groove of the second holding member at a position being away in a drawing direction of the optical fiber from an end of the positioning groove in the drawing direction;
an optical element to be mounted on the second surface of the first holding member and to be optically coupled with the optical fiber via the optical path conversion surface; and
a semiconductor circuit element to be mounted on the second surface of the first holding member.

8. The optical communication module according to claim 7, wherein the first holding member further comprises an optical groove with the optical path conversion surface formed therein, and
wherein the second holding member is configured so as to cover the optical groove.
